(19) United States
(12) Patent Application Publication
(10) Pub. No.: US 2026/0273543 A1
(43) Pub. Date: Sep. 17, 2026

(54) WET MAGNETIC ROLL SEPARATOR SYSTEMS AND METHODS OF PRODUCING HIGH-PURE IRON ORE CONCENTRATES

(71) Applicant: Dehua ZHU, New York, NY (US)

(72) Inventor: Dehua ZHU, New York, NY (US)

(21) Appl. No.: 19/076,131

(22) Filed: Mar. 11, 2025

(51) Int. Cl. B03C 1/16; B03C 1/005; B03C 1/033

(52) U.S. Cl. CPC B03C 1/16; B03C 1/005; B03C 1/0332; B03C 2201/18

(57) ABSTRACT

A wet magnetic roll separator and methods of separating iron ore concentrates by washing the magnetic products adhered on a conveyor belt around a magnetic roll and an idle roll, wherein the idle roll is positioned at an elevation above the magnetic roll.

### FIELD

This disclosure relates to a wet magnetic roll separator and an improved method of separating iron ore concentrates.

### BACKGROUND

In existing systems, permanent magnet roll magnetic separators are used for dry material separation, such as dry iron ore materials. Such systems are not designed to be used for wet materials or slurries of iron ore compositions or samples, and are therefore referred to as “dry-type magnetic roll separators.” One problem with the dry-type magnetic roll separators is that the magnetic products isolated are not of high purity. Moreover, the dry-type magnetic roll separators fail to isolate very fine particles because the fine or ultra-fine particles tend to adhere to each other. For example, when using a dry-type magnetic roll separator to process very fine iron ore samples, as shown in FIGS. 3 and 4, the iron contents in the magnetic products are almost the same as that of the original feed material. What is needed is an efficient separation system applicable to wet materials and compositions that contain fine particles, wherein the system results in high purity of magnetic products.

### SUMMARY

In an embodiment, the wet-type of magnetic roll separator includes an idler roll, a driven magnetic roll carrying magnets about its circumference, a belt in contact with the rolls, a feeding device, a water washing device with multiple spray holes and a discharging system with multiple spray holes, a frame with height-adjustable functions, a hopper for collecting magnetic products, and a hopper for collecting non-magnetic products.

In an embodiment, the wet magnetic roll separator for isolating magnetic products from an iron ore composition comprises a conveyor belt in contact with a magnetic roll and an idle roll, wherein the magnetic roll is powered by a motor. The magnetic roll comprises at least one permanent magnet. The idle roll is positioned at an elevation above the magnetic roll, such that the conveyor belt is disposed at a non-horizontal angle. The wet magnetic roll separator includes a feeding device positioned above the conveyor belt for depositing a slurry comprising the iron ore composition onto the conveyor belt, and a washing device positioned above the magnetic roll. The washing device includes a nozzle with at least one tube with a plurality of small holes for discharging a washing solution (e.g., water) onto the slurry deposited on the conveyor belt by the feeding device. The wet magnetic roll separator includes a magnetic product discharge device positioned below the idle roll, wherein the magnetic product discharge device includes a magnetic product discharge device nozzle for discharging water to the surface of the conveyor belt under the idle roll. The wet magnetic roll separator includes a magnetic product hopper for collecting the magnetic products discharged from the magnetic product discharge device, wherein the magnetic product hopper is positioned below the magnetic product discharge device nozzle. The wet magnetic roll separator includes a non-magnetic product discharge device positioned below the magnetic roll, wherein the magnetic product discharge device includes a non-magnetic product discharge device nozzle for discharging water to the surface of the conveyor belt under the magnetic roll. The wet magnetic roll separator includes a non-magnetic product hopper for collecting the non-magnetic products discharged from the non-magnetic product discharge device, wherein the non-magnetic product hopper is positioned below the non-magnetic product discharge device nozzle.

In an embodiment, a method is provided for producing high-pure iron ore concentrates using the wet magnetic roll separator comprising the steps of: moving the belt over the rolls in the direction toward idler roll; and directing the slurry onto the outer surface of the belt where the belt in contact with the magnetic roll. The method includes washing the magnetic products attracted and adhered on the magnetic roll with water to remove the non-magnetic products. The magnetic products and non-magnetic products are discharged by washing the surface of the belt under the areas of idle roll and magnetic roll. The magnetic products and non-magnetic products can drop into their respective collection areas (e.g., hoppers).

In an embodiment, the method for isolating magnetic products from an iron ore composition, wherein the method comprises providing a wet magnetic roll separator comprising a conveyor belt in contact with a magnetic roll and an idle roll, wherein the magnetic roll is powered by a motor. A top portion of the conveyor belt moves from the magnetic roll to the idle roll; wherein the magnetic roll comprises at least one permanent magnet; wherein the idle roll is positioned at an elevation above horizontal from the magnetic roll such that the conveyor belt is disposed at a non-horizontal angle. The method includes depositing a slurry comprising an iron ore composition onto the conveyor belt, wherein the iron ore composition comprises magnetic products and non-magnetic products. The method includes washing the slurry on the conveyor belt, wherein the washing removes the non-magnetic products from the conveyor belt as the magnetic particles remain on the conveyor belt and move towards the idle roll. The method includes removing the magnetic products from the conveyor belt using a magnetic product discharge device positioned below the conveyor belt and the idle roll, wherein the magnetic product discharge device discharges water from a magnetic product discharge device nozzle onto the surface of the conveyor belt under the idle roll. The method includes collecting the magnetic products removed from the conveyor belt into a magnetic product hopper, wherein the magnetic product hopper is positioned below the magnetic product discharge device nozzle; removing the non-magnetic products from the conveyor belt using a non-magnetic product discharge device positioned below the conveyor belt and the idle roll, wherein the non-magnetic product discharge device discharges water from a non-magnetic product discharge device nozzle onto the surface of the conveyor belt under the magnetic roll. The method includes collecting the non-magnetic products removed from the conveyor belt into a non-magnetic product hopper, wherein the non-magnetic product hopper is positioned below the magnetic product discharge device nozzle.

### BRIEF DESCRIPTION OF THE DRAWINGS

FIG. 1 is a diagram of a wet-type magnetic separator, showing various positions and angles of the incoming slurry flow, washing water flow, and product discharge flow.

FIG. 2 is a diagram of a dry-type magnetic roll section of a magnetic separator, according to the prior art.

FIG. 3 is a table showing dry separation test results for Example 1 with both grinding and non-grinding processes.

FIG. 4 is a graph comparing the iron contents of magnetic products and non-magnetic products obtained from separating dried iron ore of Example 1 using both grinding and non-grinding processes.

FIG. 5 is a table of the test results for iron ore of Example 1, obtained using both the prior dry separation method and the newly developed wet separation method.

FIG. 6 is a graph of a comparison of the magnetic products obtained from separating iron ore of Example 1 using both the dry and wet methods.

FIG. 7 is a table of the test results for iron ore of Example 2, obtained using both the prior dry separation method and the newly developed wet separation method.

FIG. 8 is a graph of a comparison of the magnetic products obtained from separating iron ore of Example 2 using both the dry and wet methods.

FIG. 9 is a table of the test results for iron ore of Example 3, obtained using both the prior dry separation method and the newly developed wet separation method.

FIG. 10 is a graph of a comparison of the magnetic products obtained from separating iron ore of Example 3 using both the dry and wet methods.

FIG. 11 is a table of the test results for iron ore of Example 4, obtained using both the prior dry separation method and the newly developed wet separation method.

FIG. 12 is a graph of a comparison of the magnetic products obtained from separating iron ore of Example 4 using both the dry and wet methods.

FIG. 13 is a table of the test results for iron ore of Examples 1-4 in terms of the iron content in the magnetic product.

FIG. 14 is a graph of the magnetic products obtained from separating iron ore of Examples 1-4 using both dry and wet methods.

FIG. 15 is a table of the test results for iron ore of Examples 1-4 in terms of the iron content in the non-magnetic products.

FIG. 16 is a graph comparing the non-magnetic products obtained from separating iron ore of Examples 1-4 using both dry and wet methods.

### DETAILED DESCRIPTION

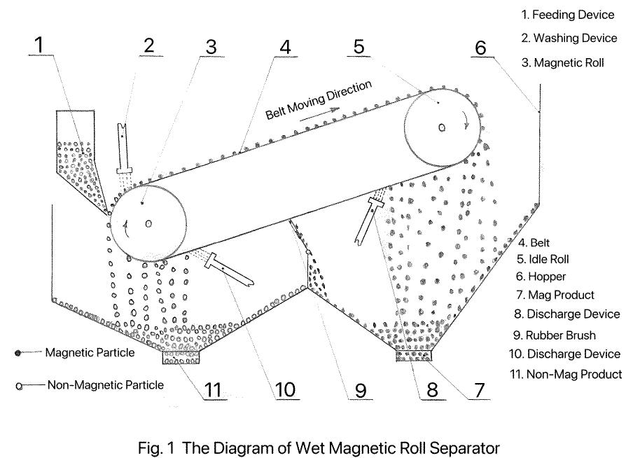

As shown in FIG. 1, one embodiment of a wet roll magnetic separator includes a feeding device 1, a water washing device 2, a magnetic roll 3, a belt 4, an idle roll 5, a hopper/tank body 6, a mag-product discharge device 8, a splitter 9, a magnetic discharge device 10, and a non-magnetic product discharge device 11, among others. The magnetic separator has advantages such as a simple structure, small space, lightweight, less energy usage, and high separation efficiency.

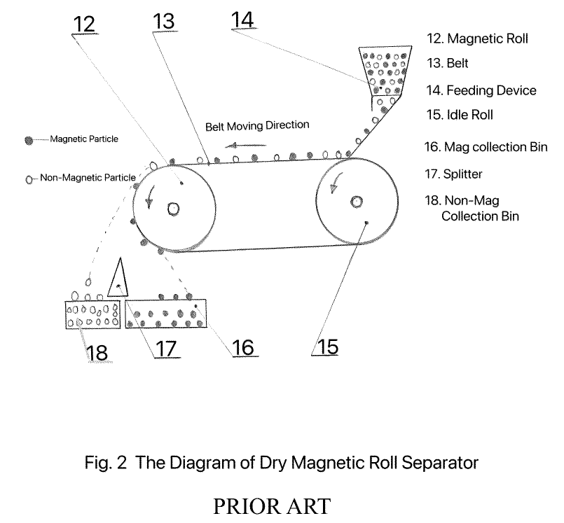

Prior magnetic roll separators, as shown in FIG. 2, consist of a magnetic roll 12, belt 13, feeder 14, idler roll 15, magnetic product bin 16, splitter 17, and non-magnetic product bin 18. The prior roll separator sorts materials based on the differences in magnetic properties and centrifugal force. The magnetic particles are attached on the magnetic roll and dropped in magnetic product bin and non-magnetic particles are rejected into non-magnetic product hopper via centrifugal force.

In contrast, the present system does not rely on centrifugal force for separation and instead uses a wet process to isolate the magnetic products from the non-magnetic products. As shown in FIG. 1, the feeding device 1 is located above the magnetic roll, and its function is to evenly deliver a slurry comprising an iron ore composition onto the belt on the surface of the magnetic roll. The feeding device is made of non-magnetic materials, and the length of the feeding port can be matched to be positioned above or meet the magnetic roll. The width of the feeding port can be adjusted to regulate the feed rate. The feeding device can be positioned at any location along or around the circumference of the magnetic roll, from 10 o'clock to 2 o'clock. For example, the 12 o'clock position can be selected. The feeding device can be equipped with a vibrator or without a vibrator.

As shown in FIG. 1, the water washing device 2 can be located relatively above the magnetic roll and includes one or more circular tubes made from non-magnetic materials (e.g., non-magnetic stainless steel). Each tube can be equipped with one or more rows of small holes arranged in a line. The number, size, and positioning of the holes in each row can be determined based on the length of the magnetic roll and the number of magnetic poles in the magnetic roll. The position and size of the holes is such to effectively wash away non-magnetic particles that are mixed with the magnetic particles. If the wash holes are relatively large, nozzles that widen the water flow can be installed. Each tube can rotate 360° for adjustment, allowing the direction of the water flow to be changed and the angle between the water flow and the belt to be regulated. The width of the washing device can match the width of the magnetic roll to ensure that the non-magnetic products can be rinsed away by the water flow. The water washing position can be at any location along the circumference of the magnetic roll between 6 o'clock and 2 o'clock; for example, at the 10 o'clock position, 11 o'clock position, or 12 o'clock position. In an example, the water washing device 2 can be at an angle plus or minus 30 degrees from vertical. The water washing position can be above the feed point on the magnetic roll.

As shown in FIG. 1, the magnetic roll 3 includes magnets (not shown), which can include rare-earth permanent magnets (e.g., neodymium iron boron) that generate a strong magnetic field, and/or ferrite magnets that generate a weaker magnetic field. For example, the magnet can be rare-earth magnets (e.g., neodymium iron boron) and/or ferrite magnets. The magnetic poles of the magnetic roll can be oriented axially or in the diameter direction. The magnetic roll can be connected and driven by a motor (not shown).

The surface of the magnetic roll can be covered with one or more waterproof layers, as the magnetic roll is prone to oxidation and wear when in contact with water. The material of the protective layers can include non-magnetic metal materials, wear-resistant non-metallic materials, or it can be a non-metallic coating. In an example, the surface of the magnetic roll can have a thin waterproof, non-magnetic layer or multi layers, which can keep the magnetic roll dry and prevent oxidation.

As shown in FIG. 1, the conveyor belt 4 extends about the magnetic roll 3 and the idle roll 5, forming an endless loop. When the motor drives the magnetic roll 3, the rotation of the magnetic roll causes the conveyor belt to move, thus transporting the slurry of iron ore composition. Different thickness of the conveyor belt can be chosen to satisfy the requirement of the magnetic field strength. Unlike the conventional dry magnetic roll separators, the material of the conveyor belt in the wet magnetic separator can be waterproof and wear-resistant. The edges of the conveyor belt can be without a skirt edge, or with a skirt edge. The direction of the conveyor belt movement is opposite to that of the conveyor belt in traditional dry drum roll separators. That is, the conveyor belt portion above the magnetic roll and idle roll moves from the magnetic roll toward the idle roll, while the belt portion below the magnetic roll and idle roll moves from the idle roll toward the magnetic roll.

The conveyor belt of the separator can have a thickness (e.g., 0.5 mm, 1.0 mm, 1.5 mm, or 2 mm) which can be used to adjust the magnetic field strength for the separation process. The belt can be angled such that the idle roll is at a height greater than the magnetic roll relative to the ground. The angle of the belt with respect to respect to the ground (i.e., horizontal) is greater than 0°(for example 15°, 18°, 20°, 25°, 30°, 35°, 40°) in order to let the washed impurity particles of the non-magnetic products to a non-magnetic collection area (e.g., non-magnetic product hopper 11). The angle of the belt can be adjustable between 0° and 90° by adjusting a screw of the frame or electronically. In an embodiment the angle is from 10° to 60°, 15° to 50°, 10° to 30°, 15° to 30°, or 15° to 20°. In an embodiment, the angle is 20°. In an embodiment, the angle is 18°.

As shown in FIG. 1, the idle roll 5 can be connected to a frame. Unlike in dry roll magnetic separators, the height of the idle roll 5 is higher than that of the magnetic roll 3 relative to horizontal. The configuration ensures that the conveyor belt has an angle relative to horizontal, allowing impurity particles flow to the non-magnetic product along with the washing water and finally drop into the non-product collecting hopper 11. The frame can be equipped with an adjusting device to adjust the relative height of the idle roll and, thereby, the angle between the magnetic roll and the idle roll with respect to horizontal.

As shown in FIG. 1, the magnetic product discharge device 8 and the non-magnetic product discharge device 10 are installed below the conveyor belt between the magnetic roll 3 and the idle roll 5. The magnetic product discharge device 8, the non-magnetic product discharge device 10, or both, include one or more pipes or tubes, each with one or more rows of small holes. In an example, the magnetic product discharge device 8, the non-magnetic product discharge device 10, or both, include two or more pipes or tubes. Each hole can be equipped with a jet nozzle or without a jet nozzle. Water can be sprayed out through these holes to the surface of the belt and discharge the magnetic product and non-magnetic product. The size, number, and relative positions of the holes, as well as the width of the belt, can be configured to ensure the magnetic particles and non-magnetic particles on the belt under the rolls are thoroughly washed off. The metal pipes of the discharge device can be made from non-magnetic metals (such as non-magnetic stainless-steel pipes) or non-metallic materials. The tubes can rotate 360°, and the water flow can be adjusted via a water pressure in the switch. The washing points for the magnetic-product discharge device 8 can be located between the idle roll 5 and the splitter 9, with the direction of the water jets opposite to the direction of the conveyor belt movement beneath the idle roll 5. The washing points for the non-magnetic product discharge device 10 can be located between the magnetic roll 3 and the splitter 9, with the direction of the water jets the same as the direction of the conveyor belt movement beneath the magnetic roll 3. The angles of the washing stream can be adjusted by rotating the tubes.

As shown in FIG. 1, the splitter 9 can be located at a central position beneath the magnetic roll 3 and the idle roll 5. In an example, the splitter 9 can be in contact with the bottom portion of the conveyor belt 4 between the magnetic roll 3 and idle roll 5. The function of the splitter 9 is to separate the magnetic products from the non-magnetic products, allowing the magnetic products to fall into the magnetic collecting hopper 7 and the non-magnetic products to fall into the non-magnetic collecting hopper 11. The splitter 9 can scrape any magnetic particles that have not been thoroughly washed into the magnetic products hopper 7. The end of the splitter 9 in contact with the conveyor belt 4 can be equipped with a soft rubber strip, which can make contact with the conveyor belt 4 and prevent the mix of magnetic products and non-magnetic products. The soft rubber may reduce wear on the belt.

The method of producing high-purity iron concentrates can include depositing the slurry via the feeding device 1 onto a portion of the surface of the conveyor belt 4 on the magnetic roll 3. Prior to deposition, the iron ore minerals in the slurry may be individually dissociated (e.g., agitated). Magnetic products in the slurry are attracted to the portion of the surface of the conveyor belt around and in contact with the magnetic roll and, move towards the top of the magnetic roll 3. Non-magnetic products, pushed by the water flow from the washing device 2, move downwards from the magnetic roll 3 and eventually leave the magnetic roll 3, falling into the non-magnetic product collection hopper 11, while the magnetic products on the conveyor belt 4 move towards the idle roll 5.

The magnetic particles that are attracted to the surface of the conveyor belt 4 on the magnetic roll 3 are washed via the washing device 2 before they move from the attraction of the magnetic roll 3 towards the idle roll 5. The washing process removes the non-magnetic products that are mixed with the magnetic products and results in a magnetic product that is clean and pure. The flow rate and angle of the water steams are adjustable such that the non-magnetic particles are washed away into the non-magnetic product hopper 11, while the magnetic particles remain attracted to the surface of the belt on magnetic roll 3.

The method includes discharging both the magnetic and non-magnetic products into the different collection hoppers 7, 11. When the magnetic particles are conveyed to the idle roll, the water flow and jet angle from magnetic products discharge device 8 can be adjusted to wash all the magnetic particles off the conveyor belt 4, allowing them to fall into the magnetic product collection area of the product magnetic product hopper 7. Similarly, the water flow and jet angle from the non-magnetic discharge device 10 are adjusted to wash off any remaining non-magnetic particles from the underside of the conveyor belt in contact with the magnetic roll 3, which then fall into the non-magnetic product hopper 11. The splitter 9 can be adjusted to ensure that the soft rubber strip at the front end of the splitter contacts the conveyor belt, preventing the mixing of the magnetic and non-magnetic products. The optimization of running speed and angle of the conveyor belt can aid in the product discharge process. In an example, the speed of the conveyor belt is from 15 rpm to 40 rpm, 20 rpm to 30 rpm, 20 rpm to 25 rpm, or 23 rpm to 26 rpm.

The method can include adjusting screws or other connectors of the frame to allow the idle roll 5 to be positioned at a higher height than that of the magnetic roll 3. The conveyor belt 4 can be positioned at a selective angle between 0° and 90° with respect to horizontal. In various embodiments the angle is from 10° to 60°, 15° to 50°, 15° to 30°, or 15° to 20°. In one specific embodiment, the angle is 20°. In another specific embodiment, the angle is 18°.

The method can include directing the slurry into a stream at an angle of the feed stream substantially perpendicular to the surface of the conveyor belt and magnetic roll; directing the slurry into a stream at an acute angle with respect to the surface of the conveyor belt 4 and the magnetic roll 3; directing the feed towards the surface of the conveyor belt 4 at a plurality of spaced positions; directing the feed with respect to the surface of such conveyor belt at a selectable angle; and adjusting the magnetic field strength to allow the magnetic products to be attracted and adhere to magnetic poles provided by the magnetic roll 3.

The method can include washing the magnetic products attracted and adhered on the conveyor belt 4 with a water stream at an opposite direction of the belt moving direction. The method can include washing the products attracted and adhered on the magnetic roll 3 at an angle of the water stream substantially perpendicular to the surface of the conveyor belt 4 and magnetic roll 3. The method can include washing the products attracted and adhered on the magnetic roll 3 at an acute angle with respect to the surface of the belt and the magnetic roll 3. In an example, the method includes selectively washing the products attracted and adhered on the magnetic roll 3 at a plurality of positions where an inner surface of the belt in in contact with the magnetic roll 3. In an example, the method includes washing the products attracted and adhered on the magnetic roll 3 at a selectable angle. In an example, the method includes washing the products attracted and adhered on the magnetic roll 3 at a selectable flow rate. In an example, the method includes washing the products attracted and adhered on the magnetic roll with single row of water stream to remove the non-magnetic products in the magnetic products. In an example, the method includes washing the products attracted and adhered on the magnetic roll with multi-row of water stream. The method can include optimizing the washing factors (flow rate, injection position, magnetic field string, etc.) to obtain a clean magnetic product.

In an example, the method can include discharging, via a magnetic discharging device 8, the magnetic products by applying forced water to the surface of the conveyor belt 4 under the idle roll 5. In an example, the method can include discharging the non-magnetic products by applying forced water to the surface of belt under the magnetic roll 3. The non-magnetic discharging device 10 can include single row holes or multi-rows of holes. The diameter of the hole can be in the range of 0.1-10.0 mm. The hole(s) of the magnetic discharge device 8 and/or the non-magnetic discharging device 10 can be with or without injection devices which used to adjust the width of the water injection. The magnetic discharge device 8 and/or the non-magnetic discharging device 10 can include of a single-row device or several single-row devices.

The high-purity iron concentrate resulting from the system and method disclosed herein is iron concentrate with an iron oxide content greater than 97.00%, which corresponds to an iron content greater than 70.23%. The resulting high-purity iron concentrate plays a significant role in reducing carbon dioxide emissions and energy consumption in iron & steel making.

### EXAMPLES

In the following examples, dry magnetic separation and wet magnetic separation were conducted on four iron ore samples (Examples 1-4) sourced from U.S. mines by using a dry-type roll separator as shown in FIG. 2 and the present wet-type roll separator shown in FIG. 1. The roll speed for the dry-type roll separator used in the examples was 150 rpm. The roll speed for the present wet-type roll separator was 25 rpm. The angle of the conveyor belt from the magnetic roll to the idle roll in the wet-type roll separator was 18° from horizontal.

As illustrated in the examples below, the average iron content of the four samples is 65.51% by using traditional dry-type roll separator. The average iron content of the four samples is 70.67% by using the present wet-type roll separator. Therefore, high-pure iron ore concentrates are produced using the present wet magnetic roll separator with Fe₃O₄ purity of 97.61%.

### Example 1

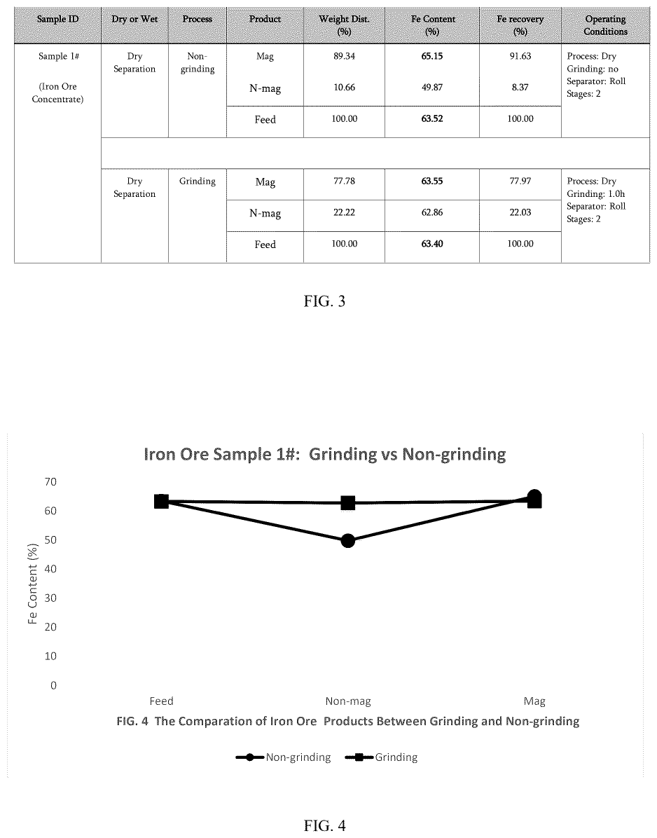

As shown in FIG. 3 and FIG. 4, dry separation with both grinding and non-grinding was conducted. FIG. 3 illustrates the test results for both the dry and wet separations. It can be seen from FIG. 3 that iron content is increased from 63.52% to 65.15% without grinding process, while the iron content is increased from 63.40% to 63.55% with grinding process. Both dry processes (with or without grinding) does not obtain the required high-purity iron ore concentrates. FIG. 4 shows that dry separation without grinding process can get a higher purity iron content than that with grinding process.

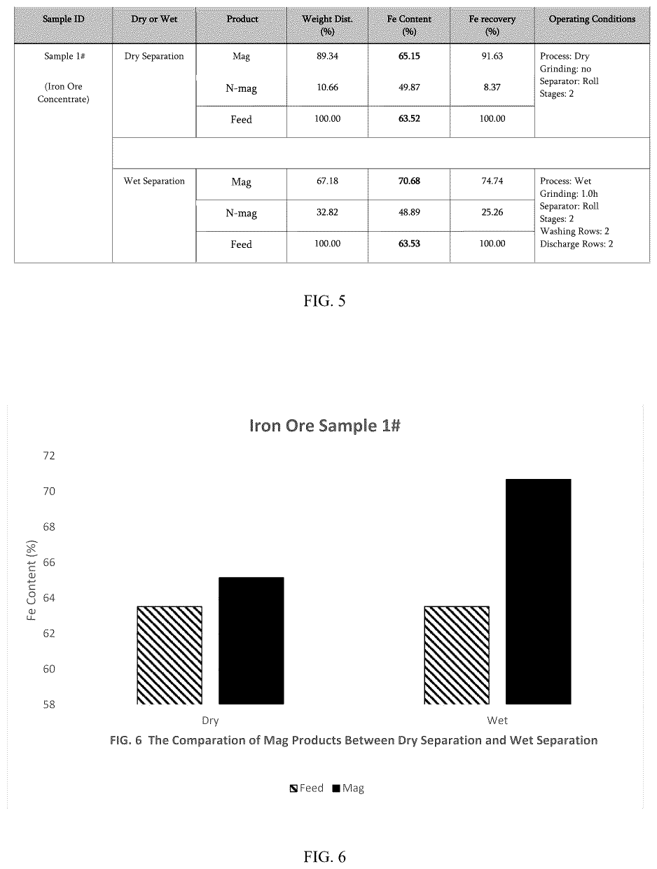

FIG. 5 and FIG. 6 illustrate the results from FIG. 3 and FIG. 4, wherein FIGS. 5-6 illustrate comparative tests of dry and wet magnetic separation were conducted on sample 1. The iron grade of the dry magnetic separation concentrate was 65.15%, while the iron grade of the wet magnetic separation concentrate was 70.68%. Therefore, the present wet magnetic roll separator and method can produce high-purity iron ore concentrate from iron ore from sample 1 with magnetite (Fe₃O₄) purity of 97.62%. FIG. 6 shows that the present wet magnetic roll separator and method can result in higher-purity magnetic products than a dry process in terms of iron content.

### Example 2

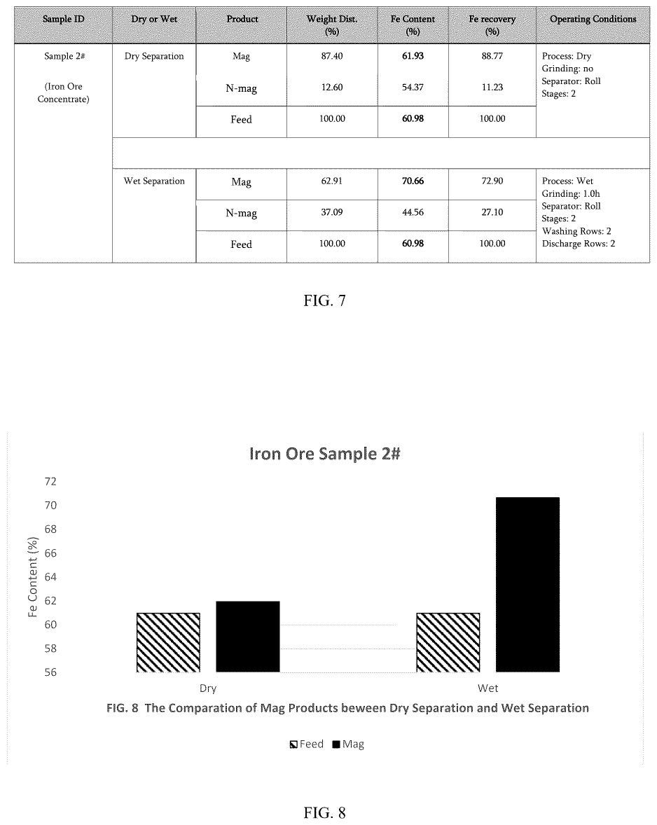

As shown in FIG. 7 and FIG. 8, comparative tests of dry and wet magnetic separation were conducted on sample 2. The iron grade of the dry magnetic separation concentrate was increased from 60.98% to 61.93%, while the iron grade of the wet magnetic separation concentrate was increased from 60.98% to 70.66%. Therefore, the wet magnetic roll separator and method can produce high-purity iron ore concentrate from the iron ore of sample 2 with magnetite (Fe₃O₄) purity of 97.60%. FIG. 8 shows that the present wet magnetic roll separator and method can result in higher-purity magnetic products than a dry process in terms of iron content.

### Example 3

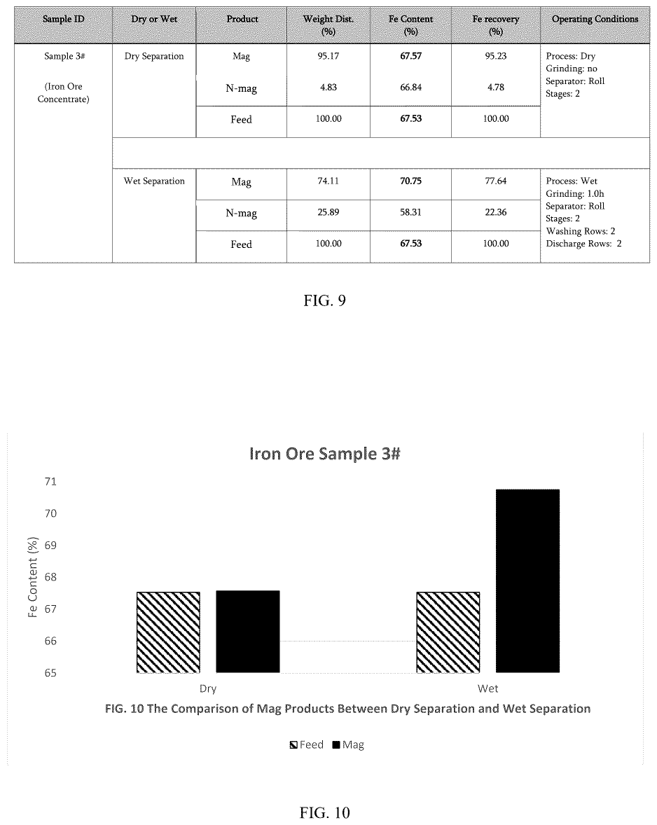

As shown in FIG. 9 and FIG. 10, comparative tests of dry and wet magnetic separation were conducted. The iron grade of the dry magnetic separation concentrate was increased from 67.53% to 67.57%, while the iron grade of the wet magnetic separation concentrate was increased from 67.53% to 70.75%. Therefore, the wet magnetic roll separator and method can produce high-purity iron ore concentrate from iron ore of sample 3 with magnetite (Fe₃O₄) purity of 97.72%. FIG. 10 shows that the present wet magnetic roll separator and method can result in higher-purity magnetic products than a dry process in terms of iron content.

### Example 4

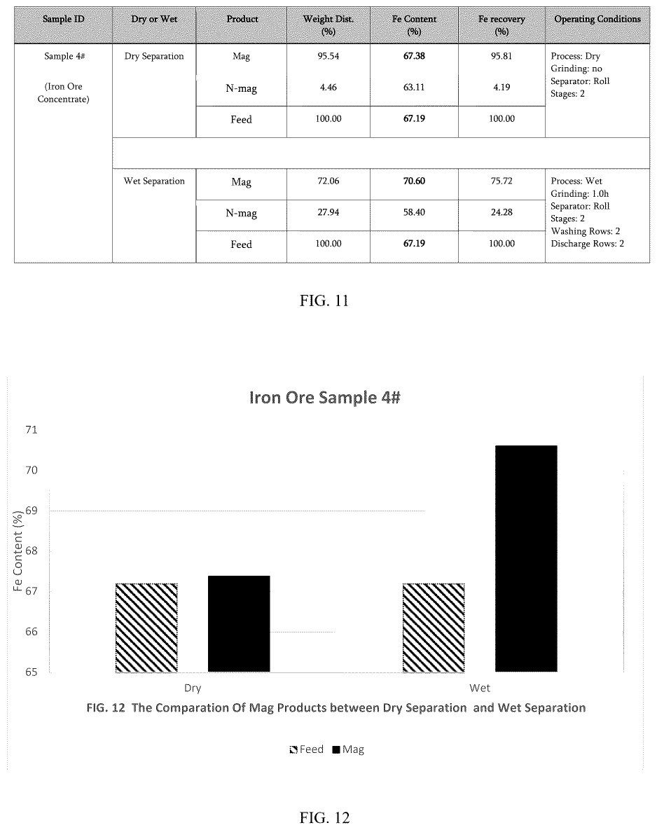

As shown in FIG. 11 and FIG. 12, comparative tests of dry and wet magnetic separation were conducted. The iron grade of the dry magnetic separation concentrate was increased from 67.19% to 67.38%, while the iron grade of the wet magnetic separation concentrate was increased from 67.19% to 70.60%. Therefore, the wet magnetic roll separator and method can produce high-purity iron ore concentrate from iron ore of Example 4 with magnetite (Fe₃O₄) purity of 97.51%. FIG. 12 shows that the present wet magnetic roll separator and method can result in higher-purity magnetic products than a dry process in terms of iron content.

### Magnetic Products:

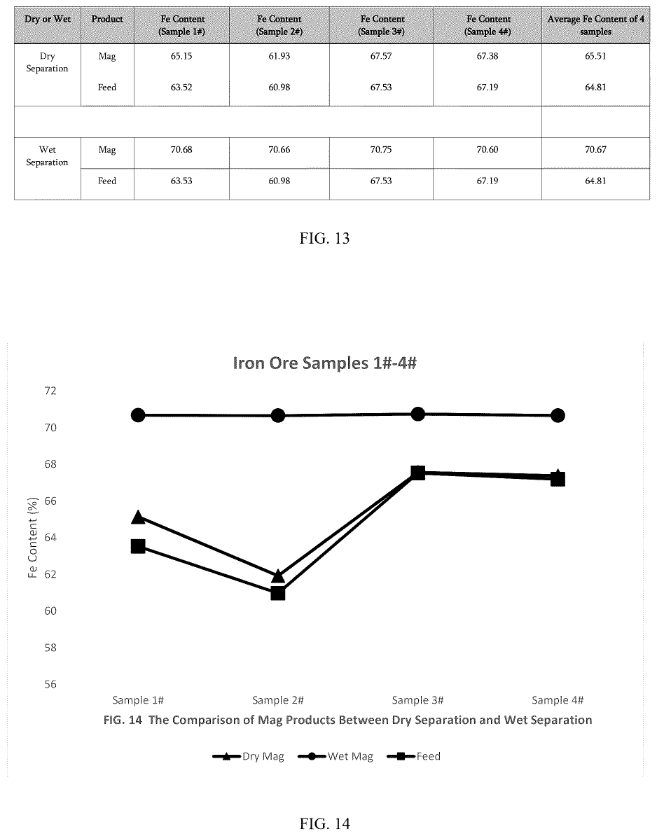

As shown in FIG. 13 and FIG. 14, compared to the feed material, the average iron grade of the four concentrates from dry magnetic separation was increased from 64.81% to 65.51%, showing only a small increase in grade. In contrast, the average iron grade of the four concentrates from wet magnetic separation was increased from 64.81% to 70.67%, showing a significant increase. This indicates that wet separation performs better than dry separation in terms of iron content of magnetic products. The average content of magnetite (Fe₃O₄) in the four iron concentrates was 97.61%, demonstrating that high-purity iron concentrate can be produced from all four iron ore samples.

### Non-Magnetic Products:

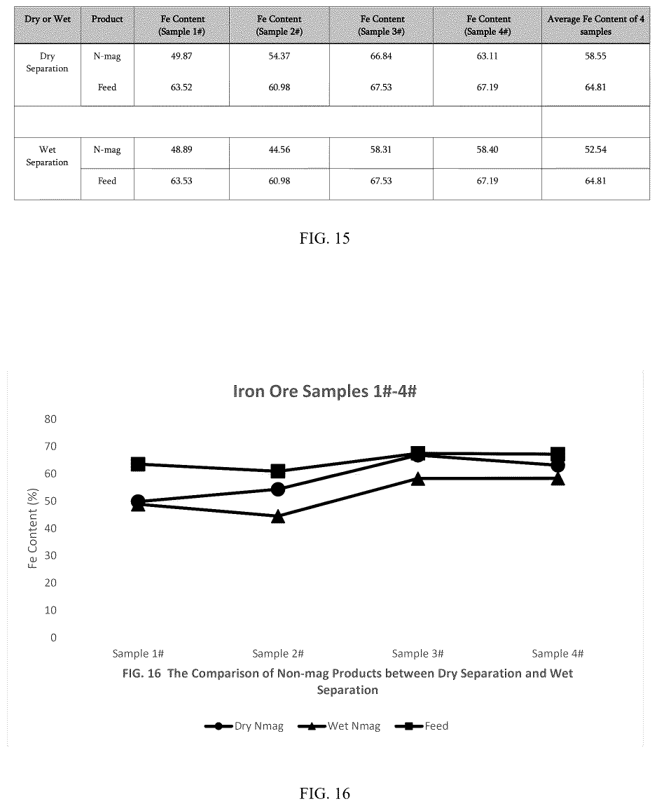

As shown in FIG. 15 and FIG. 16, compared to the feed material, the average iron grade of the four tailings from dry magnetic separation was decreased from 64.81% to 58.55%, showing only a small decrease in grade. In contrast, the average iron grade of the four tailings or non-magnetic products from wet magnetic separation was decreased from 64.81% to 52.54%, showing a more significant decrease. This indicates that the wet magnetic roll separator and method performs better than the dry separation method.

1. A wet magnetic roll separator for isolating magnetic products from an iron ore composition, wherein the wet magnetic roll separator comprises:
a conveyor belt extending between a magnetic roll and an idle roll, wherein the magnetic roll comprises at least one permanent magnet, wherein magnetic poles of the magnetic roll are oriented axially with respect to the magnetic roll, wherein the permanent magnet comprises neodymium; wherein the idle roll is positioned at an elevation above the magnetic roll, such that the conveyor belt is disposed at a non-horizontal angle, wherein the angle of the conveyor belt is from 10 degrees to 60 degrees above horizontal;
a feeding device positioned above the conveyor belt for depositing a slurry comprising the iron ore composition onto a portion of the conveyor belt adjacent the magnetic roll;
a washing device positioned above the magnetic roll, wherein the washing device includes a nozzle with at least one tube with a plurality of small holes for discharging a washing solution onto the slurry deposited on the conveyor belt by the feeding device;
a magnetic product discharge device positioned below the idle roll, wherein the magnetic product discharge device includes a magnetic product discharge device nozzle for discharging water to the surface of the conveyor belt under the idle roll;
a magnetic product hopper for collecting the magnetic products discharged from the magnetic product discharge device, wherein the magnetic product hopper is positioned below the magnetic product discharge device nozzle;
a non-magnetic product discharge device positioned below the magnetic roll, wherein the non-magnetic product discharge device includes a non-magnetic product discharge device nozzle for discharging water to the surface of the conveyor belt under the magnetic roll; and
a non-magnetic product hopper for collecting the non-magnetic products discharged from the non-magnetic product discharge device, wherein the non-magnetic product hopper is positioned below the non-magnetic product discharge device nozzle, wherein the non-magnetic product discharge device and the non-magnetic product hopper define a non-magnetic product discharge path separate from the feeding device.

2. The wet magnetic roll separator of claim 1, wherein the magnetic roll is powered by a motor.

3. The wet magnetic roll separator of claim 1, further comprising a splitter positioned beneath the conveyor belt and between the magnetic roll and idle roll.

4. The wet magnetic roll separator of claim 3, wherein the splitter includes a rubber end in contact with a bottom surface of the conveyor belt.

5. The wet magnetic roll separator of claim 3, wherein the splitter does not include a rubber end.

6. The wet magnetic roll separator of claim 1, wherein the angle of the conveyor belt is from 15 degrees to 50 degrees above horizontal.

7. The wet magnetic roll separator of claim 1, wherein the angle of the conveyor belt is from 10 degrees to 30 degrees above horizontal.

8. The wet magnetic roll separator of claim 1, wherein the angle of the conveyor belt is from 15 degrees to 20 degrees above horizontal.

9. The wet magnetic roll separator of claim 1, further comprising a frame, wherein the idle roll and magnetic roll are connected to the frame.

10. A method for isolating magnetic products from an iron ore composition, wherein the method comprises:
providing the wet magnetic roll separator of claim 1;
depositing the slurry onto the surface of the conveyor belt in contact with the magnetic roll, wherein the slurry comprises the iron ore composition including non-magnetic products and magnetic products;
washing the slurry on the surface of the belt with the washing device;
discharging the non-magnetic products using the non-magnetic product discharge device into the non-magnetic product hopper; and
discharging the magnetic products using the magnetic product discharge device into the magnetic product hopper.

11. A method for isolating magnetic products from an iron ore composition, wherein the method comprises:
providing a wet magnetic roll separator comprising a conveyor belt in contact with a magnetic roll and an idle roll, wherein the magnetic roll is powered by a motor, wherein a top portion of the conveyor belt moves from the magnetic roll to the idle roll; wherein the magnetic roll comprises at least one permanent magnet, wherein magnetic poles of the magnetic roll are oriented axially with respect to the magnetic roll, wherein the permanent magnet comprises neodymium; wherein the idle roll is positioned at an elevation above the magnetic roll, such that the conveyor belt is disposed at a non-horizontal angle, wherein the angle of the conveyor belt is from 10 degrees to 60 degrees above horizontal;
depositing a slurry comprising the iron ore composition onto a portion of the conveyor belt in contact with the magnetic roll, wherein the iron ore composition comprises magnetic products and non-magnetic products;
washing the slurry on the conveyor belt, wherein the washing removes the non-magnetic products from the conveyor belt as the magnetic particles remain on the conveyor belt and move towards the idle roll;
removing the magnetic products from the conveyor belt using a magnetic product discharge device positioned below the conveyor belt and the idle roll, wherein the magnetic product discharge device discharges water from a magnetic product discharge device nozzle onto the surface of the conveyor belt under the idle roll;
collecting the magnetic products removed from the conveyor belt into a magnetic product hopper, wherein the magnetic product hopper is positioned below the magnetic product discharge device nozzle, wherein the isolated magnetic products have an iron oxide content of greater than 97.00%;
removing the non-magnetic products from the conveyor belt using a non-magnetic product discharge device positioned below the conveyor belt and the magnetic roll, wherein the non-magnetic product discharge device discharges water from a non-magnetic product discharge device nozzle onto the surface of the conveyor belt under the magnetic roll; and
collecting the non-magnetic products removed from the conveyor belt directly into a non-magnetic product hopper, wherein the non-magnetic product hopper is positioned below the non-magnetic product discharge device nozzle.

12. The method of claim 11, further comprising adjusting the angle between the magnetic roll and the idle roll, wherein the conveyor belt is disposed between 15 degrees and 50 degrees above horizontal.

13. The method of claim 11, further comprising adjusting the angle between the magnetic roll and the idle roll, wherein the conveyor belt is disposed between 10 degrees and 30 degrees above horizontal.

14. The method of claim 11, further comprising adjusting the angle between the magnetic roll and the idle roll, wherein the conveyor belt is disposed between 15 degrees and 20 degrees above horizontal.

15. The method of claim 11, wherein the washing includes applying a force stream of water to the conveyor belt, wherein the direction of the force stream is opposite from the direction of the conveyor belt.

16. The method of claim 11, further comprising contacting a splitter to a bottom portion of the conveyor belt, wherein the splitter is positioned beneath the conveyor belt and between the magnetic roll and idle roll, wherein the splitter removes the magnetic products from the conveyor belt.

17. The method of claim 16, wherein the splitter has a rubber end in contact with the bottom portion of the conveyor belt.

18. The method of claim 16, wherein the splitter does not have a rubber end.

19. The wet magnetic roll separator of claim 1, wherein the conveyor belt has a thickness of 0.5 mm to 2.0 mm.

20. The method of claim 11, wherein the conveyor belt has a thickness of 0.5 mm to 2.0 mm.
